(19) United States
(12) Patent Application Publication
(10) Pub. No.: US 2011/0113079 A1
(43) Pub. Date: May 12, 2011

(54) INFORMATION SWITCH MODULE AND RELATED FILE TRANSFER METHOD

(75) Inventors: Fan-Di Jou, Chiayi City (TW); Chong-Yie Chang, Changhua County (TW)

(73) Assignee: INDUSTRIAL TECHNOLOGY RESEARCH INSTITUTE, Hsinchu (TW)

(21) Appl. No.: 12/647,403

(22) Filed: Dec. 25, 2009

(30) Foreign Application Priority Data
Nov. 11, 2009 (TW) 98138274

(51) Int. Cl. G06F 12/00; G06F 13/00; G06F 13/12

(52) U.S. Cl. 707/827; 703/21; 710/300; 711/115; 711/162; 711/159; 707/E17.01; 711/E12.001

(57) ABSTRACT

An information switch module and a related file transfer method are disclosed. The information switch module is coupled to a first and a second host. The information switch module includes a switch and a storage device, and the switch includes at least a system controller, a first and a second USB controllers and an input device connection module. The system controller uses the storage device to simulate at least two USB mass storage device, and sets up an output storage space and an input storage space in the at least two USB mass storage devices, respectively. The first and second hosts access the output storage space and the input storage space through the first and second USB controllers, respectively. After the first host stores a file into the output storage space, the system controller provides a corresponding data of the file to the input storage space for the second host.

### CROSS-REFERENCE TO RELATED APPLICATION

This application claims the priority benefit of Taiwan application serial no. 98138274, filed Nov. 11, 2009. The entirety of the above-mentioned patent application is hereby incorporated by reference herein and made a part of specification.

### BACKGROUND

1. Technical Field

The present disclosure relates to a device and a method for transferring files through an information switch module.

2. Background Description

As computer technology is well popularised, some organizations (such as private companies or government agencies) may purchase a plurality of computer hosts to serve as various servers. To facilitate maintenance/management, the hosts are generally located in a computer room. A manager of the computer room may often perform data transmission among different hosts in the computer room.

A general file transfer method of the conventional technique is to provide a file-sharing mechanism through a local area network (LAN) according to a file transfer protocol (FTP). However, such file transfer method requires an extra FTP server, so that a system cost is increased. Moreover, the FTP technique is applied based on users, and when different hosts have different administrators, the FTP file-sharing mechanism is not convenient for different managers to use. Frequently files are placed in a public area with risks of unauthorized access.

Another conventional file transfer method is to provide a common data storage area for the hosts. However, according to such method, data in the common data storage area are exposed to a plurality of user, so that a data security is decreased.

### SUMMARY

The present disclosure provides an information switch module, which is used for providing an input device to one of a plurality of hosts, and serves as an information switch and transfer medium among the hosts. The hosts at least include a first host and a second host. The information switch module includes a switch and a storage device, and the switch includes at least a system controller, a first and a second Universal Serial Bus (USB) interface controllers and an input device connection module. The system controller is coupled to the storage device for managing and controlling the storage device. The system controller uses the storage device to simulate at least two simulated USB mass storage devices, and sets up an output storage space and an input storage space in the at least two simulated USB mass storage devices, respectively. The first USB interface controller is coupled to the system controller and the first host, and the first host accesses the output storage space through the first USB interface controller. The second USB interface controller is coupled to the system controller and the second host, and the second host accesses the input storage space through the second USB interface controller. The input device connection module is coupled to at least one input device, the first USB interface controller and the second USB interface controller, and is used for providing the at least one input device to the first host, and providing a virtual device signal corresponding to the at least one input device to the second host. Wherein, after the first host stores at least one file into the output storage space, the system controller provides a corresponding data of the at least one file to the input storage space for the second host.

The present disclosure provides a file transfer method applying an information switch module to perform information switch and transfer among a plurality of hosts. The hosts at least include a first host and a second host. The file transfer method includes following steps. First, at least two simulated USB mass storage devices are simulated in a storage device. Next, an output storage space is set in one of the at least two simulated USB mass storage devices, and an input storage space is set in another one of the at least two simulated USB mass storage devices. Next, the output storage space is configured to the first host. Next, at least one file is stored in the output storage space, and a corresponding data of the at least one file is provided to the input storage space for the second host.

Several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram illustrating an information switch module according to an embodiment of the present disclosure.

FIG. 2 and FIG. 3 are schematic diagrams illustrating two equivalent structures of an information switch module of FIG. 1.

FIG. 4 and FIG. 5 are schematic diagrams illustrating two file transfer paths of an information switch module of FIG. 1.

FIGS. 6-10 are flowcharts illustrating file transfer methods applying an information switch module.

### DESCRIPTION OF THE EMBODIMENTS

A keyboard-Video-mouse switch (KVM switch) is a commonly used electronic equipment. A computer room manager generally uses the KVM switch to maintain/manage a plurality of hosts in a computer room. Therefore, the present disclosure provides an infatuation switch module integrated with the KVM and a related file transfer method, so that a administrator (the computer room manager) can use the information switch module to maintain/manage the hosts in the computer room, and can further use the information switch module as a file transfer or information switch medium among the hosts.

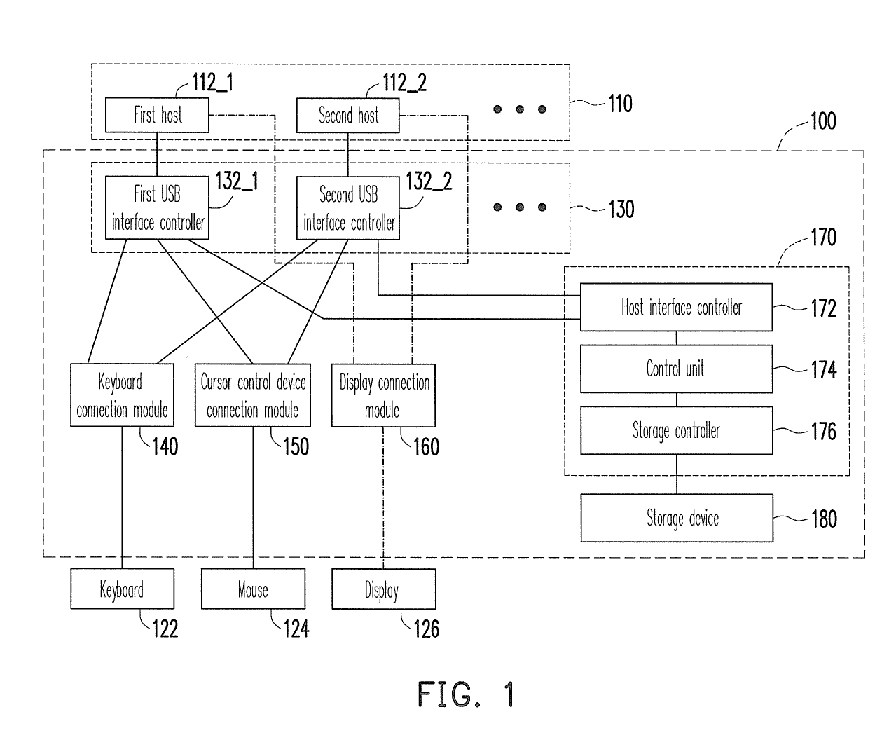

Referring to FIG. 1, FIG. 1 is a schematic diagram illustrating an information switch module according to an embodiment of the present disclosure. The information switch module 100 of the present embodiment is selectively coupled to a host group 110, a keyboard 122, a cursor control device 124, and a display 126. The cursor control device 124 can be a mouse, a trackball, a touch panel, a touch screen a trackpoint, a light pen, and an infrared positioning device, etc. that can control movement of a cursor. A screen of the display 126 can be a touch screen or a non-touch screen. The host group 110 includes a plurality of hosts 112_1, 112_2, . . . , and 112_N, wherein N is a positive integer, and in FIG. 1, only the first and the second hosts 112_1 and 112_2 are illustrated. Since the hosts 112_1-112_N can be used as servers, the host group 110 can also be referred to as a server array or a server farm.

The information switch module 100 includes a switch and a storage device 180. As shown in FIG. 1, the switch includes a host interface controller module 130, a system controller 170, and an input device connection module. The input device connection module selectively includes a keyboard connection module 140, and/or a cursor control device connection module 150. The switch can further selectively include a display connection module 160. The storage device 180 can be built in the switch, or can be an external storage device connected to the switch through a Universal Serial Bus (USB), an external serial ATA (ESATA), an Ethernet, an optical fibre, or an IEEE 1394 interface, etc.

The host interface controller module 130 includes a plurality of host interface controllers. Each of the host interface controllers is connected to a corresponding host through one or a plurality of interfaces (for example, a USB, a high definition multimedia interface (HDMI), a display port, an IEEE 1394, or other interfaces). The host interface controller module 130, the keyboard connection module 140, the cursor control device connection module 150, the system controller 170 and the storage device 180 can use the USB technique, and the display connection module 160 can use specifications of VGA, HDMI, DVI, display port or USB 3.0 which is not yet officially finalized.

Under a current USB 2.0 specification, the host interface controller module 130 and the display connection module 160 are different systems. However, under the USB 3.0 specification and later versions, the USB can transmit video signals. Therefore, the display connection module can be the same interface as that of the cursor control device connection module and the keyboard connection module, and the switch only provides a single type of interface to each of the hosts. If the display connection module 160 uses the USB specification, in FIG. 1, the display connection module 160 is connected to each of the host interface controllers in the host interface controller module 130. The video signal of each of the hosts is transmitted to the display connection module 160 through a corresponding host interface controller.

Moreover, the host interface controller module 130, the keyboard connection module 140, the cursor control device connection module 150, the system controller 170 and the display connection module 160 can be respectively implemented by a single chip, or can be integrated into one single chip through an application specific integrated circuit (ASIC) or a field-programmable gate array (FPGA), etc. Alternatively, a part of the modules 140, 150, and/or 160 are integrated into one single chip, or a part of the modules 140, 150, and/or 160, and the system controller 170 are integrated into one single chip, or the same functions of these modules and controllers are integrated into a corresponding function module in a single chip.

The host interface controller module 130 includes a plurality of the host interface controllers (for example, USB interface controllers) 132_1, 132_2, . . . , 132_M, wherein M is a positive integer greater than or equal to N. Each one of the host interface controllers 132_1-132_M can be a USB interface controller, and in FIG. 1, only a first host interface controller (i.e. a first USB interface controller) 132_1 and a second host interface controller (i.e. a second USB interface controller) 132_2 are illustrated. Since each USB interface controller can be connected to a plurality of USB devices, each USB interface controller can be a USB hub controller. Regarding any of the hosts in the host group 110, the host can be connected to multiple USB devices through a USB cable and the USB hub controller.

The keyboard connection module 140 is used for selectively coupling the keyboard 122 to one of the host interface controllers (for example, the host interface controller 132_1) in the host interface controller module 130, and providing a virtual keyboard signal to the other host interface controllers (for example, the host interface controller 132_2). The cursor control device connection module 150 is used for selectively coupling the cursor control device 124 (which is a mouse in the present embodiment) to one of the host interface controllers in the host interface controller module 130, and providing a virtual cursor control device signal (which is virtual mouse signal in the present embodiment) to the other host interface controllers. Therefore, when the information switch module 100 switches the keyboard 122 and the mouse 124 to one of the hosts in the host group 110, the other hosts still regard that the keyboard and the mouse are plugged. The display connection module 160 is used for selectively coupling at least one display 126 (not all shown) to one of the hosts in the host group 110.

According to a selection of the user, the information switch module 100 can couple the keyboard 122, the mouse 124 and the display 126 to one of the hosts in the host group 110, and then the user can maintain such host through the keyboard 122, the mouse 124 and the display 126. For example, when the user wants to maintain the first host 112_1, the information switch module 100 can: (1) provide the keyboard 122 to the first host 112_1 through the keyboard connection module 140 and the first host interface controller 132_1; (2) provide the cursor control device (for example, the mouse 124) to the first host 112_1 through the cursor control device connection module 150 and the first host interface controller 132_1; and (3) provide the display 126 to the first host 112_1 through the display connection module 160. Now, the information switch module 100 can provide a virtual keyboard and a virtual cursor control device (for example, a virtual mouse) to each of the other hosts in the host group 110.

The system controller 170 includes a host interface controller 172, a control unit 174 and a storage controller 176. The host interface controller 172 can be a USB interface controller, which is used for providing USB mass storage devices to the hosts in the host group 110. The control unit 174 uses physical storage spaces in the storage device 180 to simulate the aforementioned USB mass storage devices, and receives/executes related storage commands sent from the host interface controller 172. The storage controller 176 is used for performing actual (physical) accessing operations to the storage device 180. Besides physical control commands, an operating system is required to establish a logical file system for accessing files. Taking a commonly used file system of a file allocation table (FAT) as an example, it has a high compatibility, and the system controller 170 can establish/manage the FAT according to a FAT format (for example, FAT12, FAT16, FAT32, or EXFAT). When the FAT is damaged, the system controller 170 can reconstruct/repair the FAT.

For example, regarding each of the hosts in the host group 110, the system controller 170 uses the physical storage spaces in the storage device 180 to simulate an output storage space S1 and an input storage space S2, and provides the output storage space S1 and the input storage space S2 to the host for utilization. In other words, if the host group 110 has N hosts, the system controller 170 uses the storage device 180 to simulate N output storage spaces S1 and N input storage spaces S2, and each host can be assigned with one output storage space S1 and one input storage space S2.

Regarding any of the hosts in the host group 110, the assigned output storage space S1 and the input storage space S2 can be respectively a simulated USB mass storage device. Taking the first host 112_1 as an example, the first host 112_1 can be coupled to the first host interface controller 132_1 (i.e. the first USB interface controller) through a USB cable, and the first host interface controller 132_1 can be a USB hub controller. Since the USB has a characteristic of fan connection, the first host 112_1 can detect four USB devices through the first host interface controller 132_1, wherein the four USB devices include a keyboard (which can be the physical keyboard 122 or a virtual keyboard), a cursor control device (which can be the physical mouse 124 or a virtual mouse), the output storage space S1 and the input storage space S2. Regarding the first host 112_1, the output storage space S1 and the input storage space S2 are respectively equivalent to a USB flash drive. Certainly, the output storage space S1 and the input storage space S2 assigned to any of the hosts can also be two data folders in a single simulated USB mass storage device.

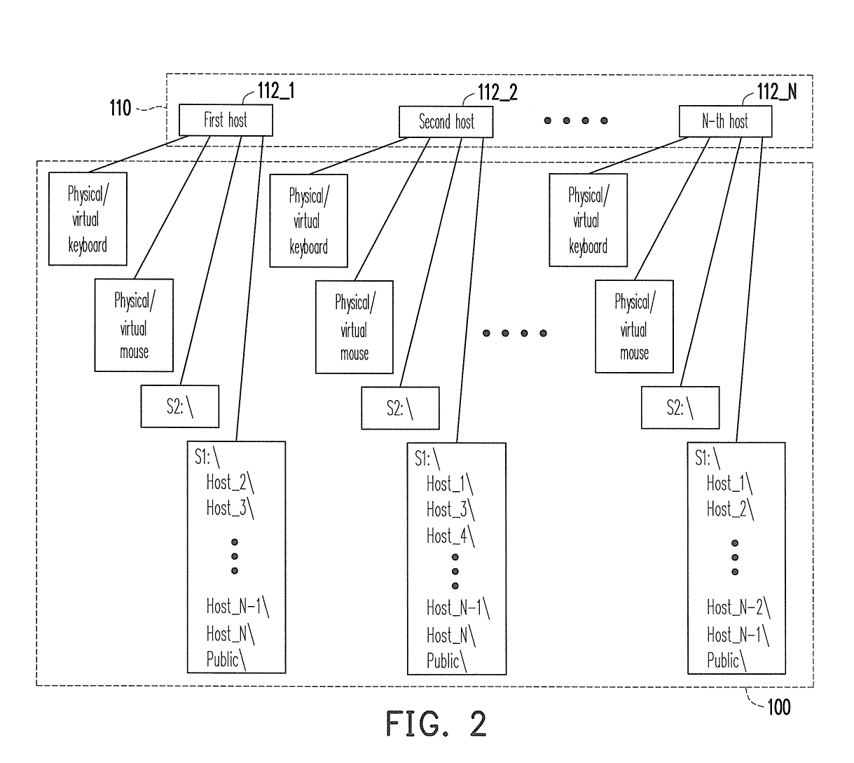

Each of the output storage space S1 contains a one-to-many data folder and a plurality of data folders corresponding to the other hosts in the host group 110. Taking the first host 112_1 as an example, the assigned output storage space S1 thereof contains data folders Host_2, Host_3, . . . , and Host_N, and a one-to-many data folder Public. Regarding the host group 110, an equivalent structure of the information switch module 100 is as that shown in FIG. 2.

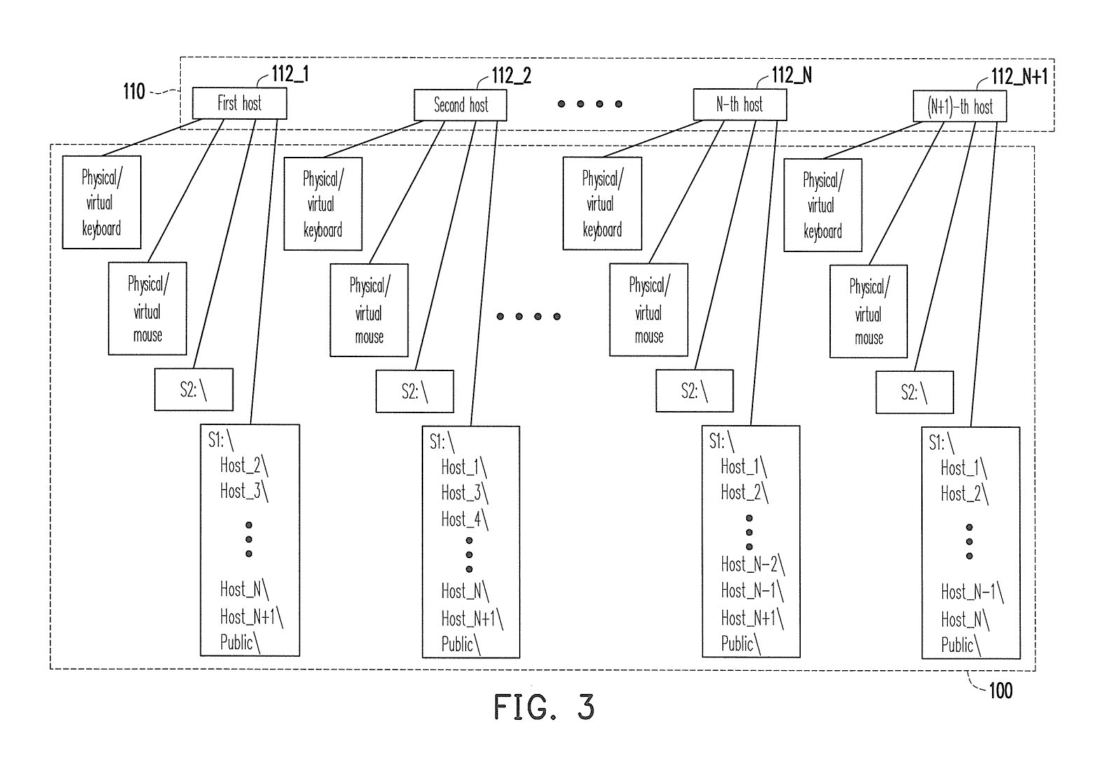

The system controller 170 can automatically establish the data folders in the output storage spaces S1 according to a situation that the hosts are added to or removed from the host group 110. For example, when an (N+1)-th host 112_N+1 is added to the host group 110, and is coupled to the information switch module 100, the system controller 170 adds data folders Host_N+1 corresponding to the (N+1)-th host 112_N+1 to all of the output storage spaces S1 of the hosts 112_1, 112_2, . . . , 112_N. Now, regarding the host group 110, an equivalent structure of the information switch module 100 is as that shown in FIG. 3. When the (N+1)-th host 112_N+1 is removed from the host group 110, and is no longer coupled to the information switch module 100, the system controller 170 removes the data folders Host_N+1 corresponding to the (N+1)-th host 112_N+1 from all of the output storage spaces S1 of the hosts 112_1, 112_2, . . . , 112_N. Now, regarding the host group 110, an equivalent structure of the information switch module 100 is as that shown in FIG. 2.

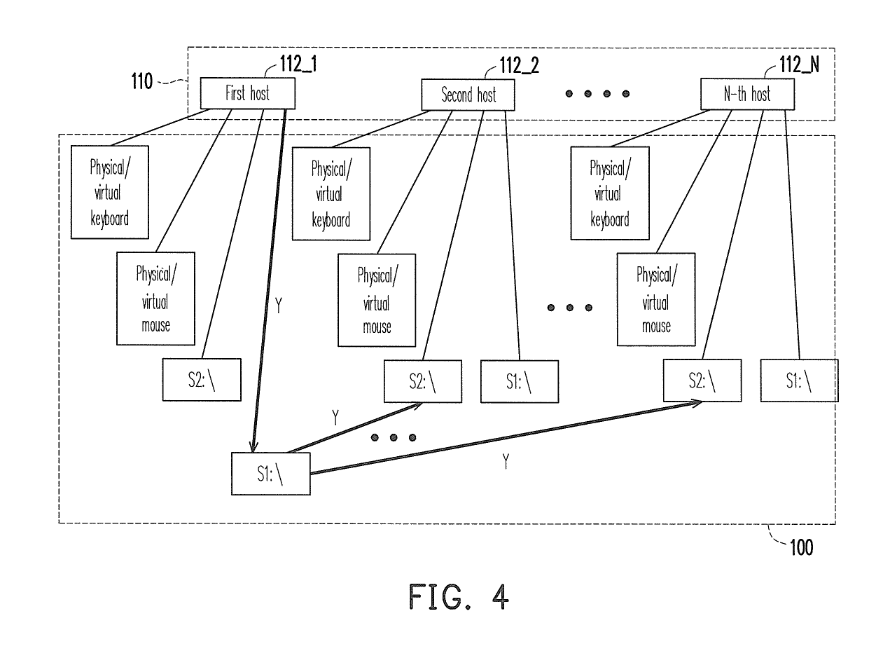

FIG. 4 is a schematic diagram illustrating a file transfer path of the information switch module 100 according to an embodiment of the present disclosure. When the user wants to transfer a file Y from the first host 112_1 to each of the other hosts 112_2-112_N through the information switch module 100, the user can store the file Y in the data folder Public of the output storage space S1 assigned to the first host 112_1. Then, the system controller 170 can automatically transfer a corresponding data of the file Y to the input storage spaces S2 assigned to the other hosts 112_2-112_N. In the present embodiment, the aforementioned corresponding data is a copy of the file Y. Namely, the system controller 170 can automatically copy the file Y in the data folder Public of the output storage space S1 to the input storage spaces S2 of the other hosts 112_2-112_N. Then, the user can use any of the hosts 112_2-112_N to fetch the file Y from its input storage space S2 for utilization.

To save a system storage resource, besides that the file Y is physically transferred to the input storage spaces S2 of the other hosts by the system controller 170, a data address translation can also be performed, so that files in the input storage spaces S2 that are detected by the other hosts are substantially the file Y in the output storage space S1 of a certain host. An address translation between the physical address in the storage device 180 and the logical addresses of the output storage spaces S1 and the input storage spaces S2 is performed by the system controller 170.

In another embodiment, when the user wants to transfer the file Y from the first host 112_1 to each of the other hosts 112_2-112_N through the information switch module 100, the user can store the file Y in the data folder Public of the output storage space S1 of the first host 112_1. Then, the system controller 170 can automatically transfer the corresponding data of the file Y to the input storage spaces S2 of the other hosts 112_2-112_N. In the present embodiment, the aforementioned corresponding data is a pointer pointed to the actual address of the file Y. Namely, the system controller 170 can automatically store the pointer in the input storage space S2 of each of the other hosts 112_2-112_N, and the pointer points to the actual address of the file Y. Then, the user can use any of the hosts 112_2-112_N to read the pointer from its input storage space S2, and then obtain the file Y from a corresponding address according to the pointer. Therefore, compared to the aforementioned embodiment, in the present embodiment, the file Y is unnecessary to be actually copied to the input storage spaces S2 of the other hosts 112_2-112_N, instead, a hardware pointer pointed to the actual address of the file Y is stored, to save the storage space.

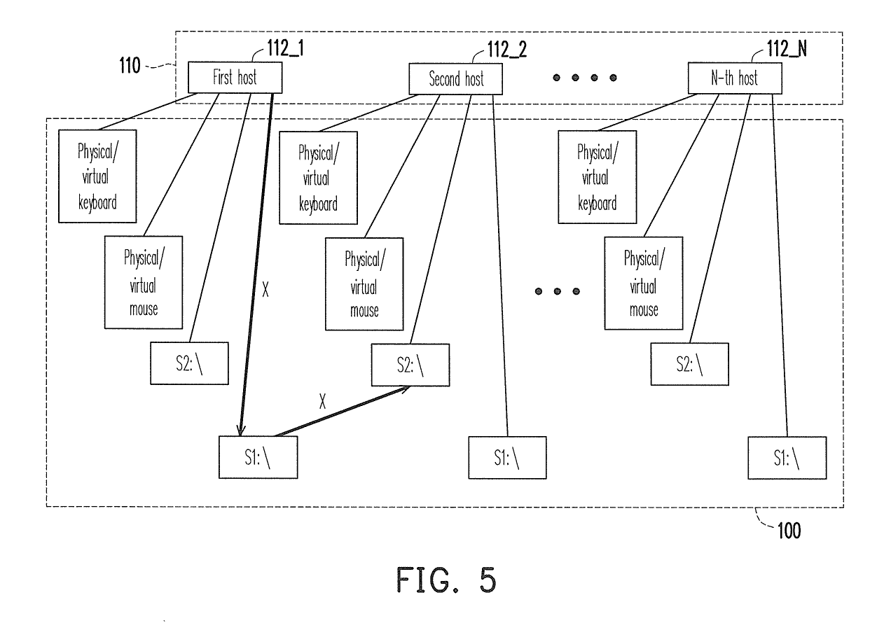

FIG. 5 is a schematic diagram illustrating a file transfer path of the information switch module 100 according to another embodiment of the present disclosure. When the user wants to transfer a file X from the first host 112_1 to the second host 112_2 through the information switch module 100, the user can store the file X in the data folder Host_2 of the output storage space S1 of the first host 112_1. Then, the system controller 170 can automatically copy the file X in the data folder Host_2 of the output storage space S1 or provide the address pointer thereof to the input storage space S2 of the second host 112_2. Then, the user can use the second host 112_2 to fetch the file X from the input storage space S2 of the second host 112_2 for utilization.

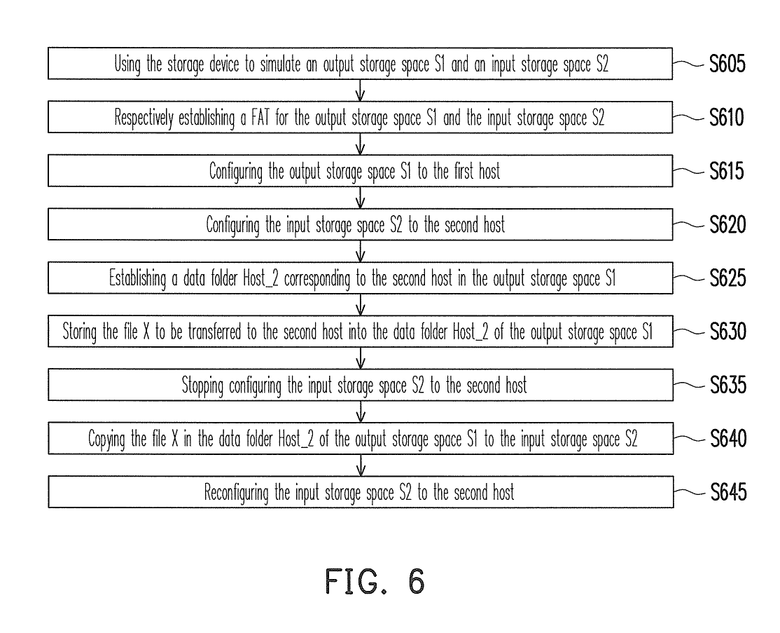

FIG. 6 is a flowchart illustrating a file transfer method corresponding to the file transfer path of FIG. 5, wherein a sequence of the steps of the method is unnecessary to be the same as that shown in FIG. 6, and the steps shown in FIG. 6 are unnecessary to be all included. In step S605, the system controller 170 uses the storage device 180 to simulate the output storage space S1 and the input storage space S2. In step S610, the system controller 170 sets up a file system (for example, a FAT file system) for each of the output storage space S1 and the input storage space S2. In step S615, the system controller 170 assigns the output storage space S1 to the first host 112_1, and in step S620, the system controller 170 assigns the input storage space S2 to the second host 112_2. In step S625, the system controller 170 establishes a data folder Host_2 corresponding to the second host 112_2 in the output storage space S1. In step S630, the first host 112_1 stores the file X to be transferred to the second host 112_2 into the data folder Host_2 of the output storage space S1. In step S635, the system controller 170 stops configuring the input storage space S2 to the second host 112_2. In step S640, the system controller 170 copies the file X in the data folder Host_2 of the output storage space S1 or provides the address pointer thereof to the input storage space S2. In step S645, the system controller 170 reconfigures the input storage space S2 to the second host 112_2.

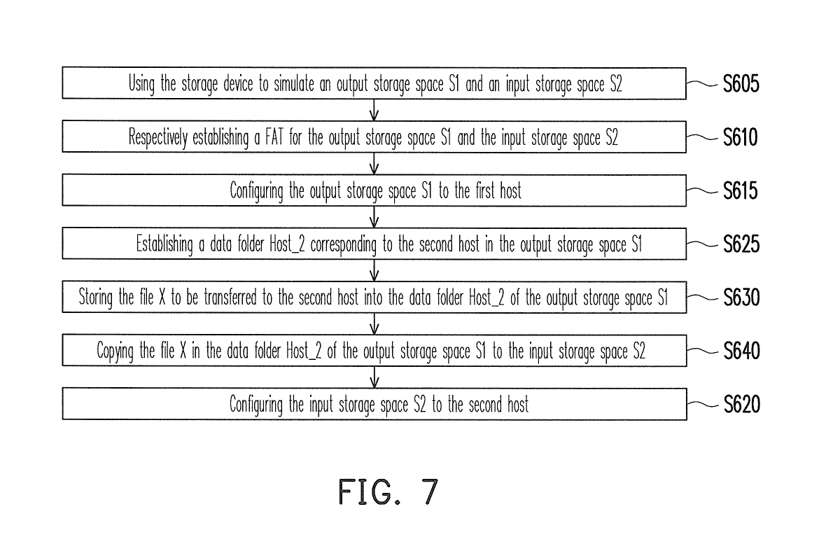

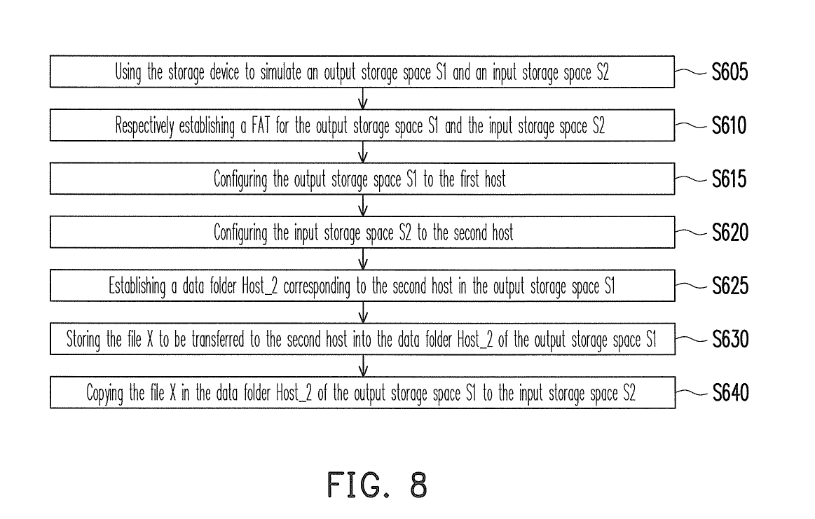

In FIG. 6, the steps S635 and S645 are used for preventing interferences probably occurred when the input storage space S2 is written. If the steps S635 and S645 are neglected, and the step S620 is moved behind the step S640, the flowchart of FIG. 6 is the same to a flowchart shown in FIG. 7. As shown in FIG. 7, since the system controller 170 does not assign an empty input storage space S2 to the second host 112_2, but only assigns the input storage space S2 stored with data to the second host 112_2, the method of FIG. 7 can also prevent the interference that is probably occurred when the input storage space S2 is written. If the interference is avoided, the steps S635 and S645 of FIG. 6 can be neglected. Now, the flowchart of FIG. 6 is the same to a flowchart shown in FIG. 8.

The information switch module 100 can further have a synchronous deletion/modification function. For example, if the user uses the first host 112_1 to delete/modify the file Y in the data folder Public of the output storage space S1 assigned to the first host 112_1, the system controller 170 can delete/modify the corresponding data of the file Y in the input storage spaces S2 assigned to the hosts 112_2-112_N.

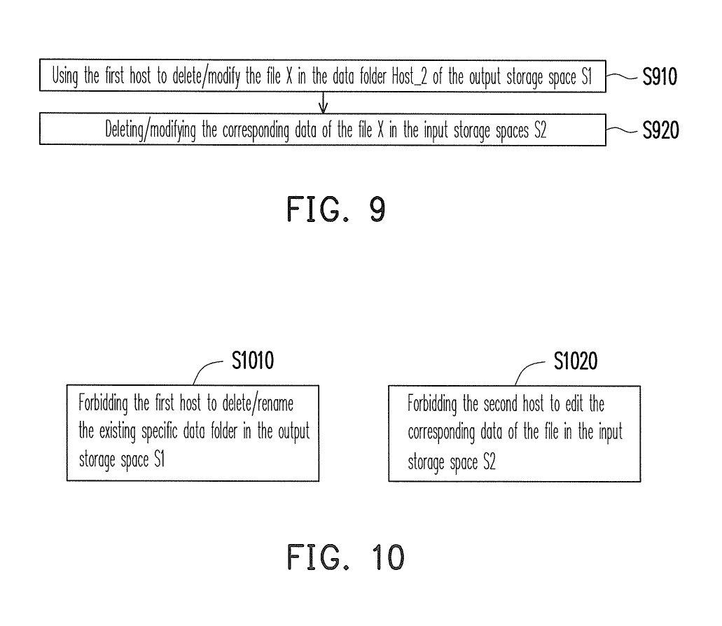

The method of synchronous deletion/modification is shown as a flowchart of FIG. 9. In step S910, the user uses the first host 112_1 to delete/modify the file X in the data folder Host_2 of the output storage space S1 of the first host 112_1, and in step S920, the system controller 170 deletes/modifies the corresponding data of the file X in the input storage spaces S2 of the second host 112_2. The flowchart of FIG. 9 can be used in coordination with the flowcharts of FIG. 6, FIG. 7 or FIG. 8. For example, the step S910 of FIG. 9 can be added behind the step S645 of FIG. 6, the step S620 of FIG. 7, or the step S640 of FIG. 8.

The system controller 170 can limit a privilege of the user of changing a root directory in any of the output storage spaces S1. When the user wants to add/remove/rename a data folder in any of the output storage spaces S1, the system controller 170 can reply the user that the data folder cannot be added/removed/renamed through a small computer systems interface (SCSI) command.

Moreover, the system controller 170 can limit a privilege of the user of using any of the input storage space S2. For example, the user may be only allowed to read and/or delete files, and may not be allowed to add a new file, and rename/edit an existing file. When the user wants to add/modify a file in a certain input storage space S2, the system controller 170 can reply the user that the file cannot be added/modified through a SCSI command.

FIG. 10 is a flowchart of examples corresponding to the above two paragraphs. In step S1010, since a specific directory of the root directory in the file system represents the host connected to the switch, the system controller 170 forbids the first host 112_1 to delete/rename the existing specific data folder in the output storage space S1, forbidding of the delete operation can be implemented by recognizing a directory name or totally forbidding adding/renaming/deleting the specific directory in the file system. In step S1020, the system controller 170 forbids the second host 112_2 to edit the corresponding data of the file in the input storage space S2. The step S1010 and/or S1020 of FIG. 10 can be used in coordination with the flowcharts of FIG. 6, FIG. 7 or FIG. 8. For example, the step S1010 of FIG. 10 can be added at any position behind the step S625 of FIG. 6, FIG. 7, or FIG. 8. The step S1020 of FIG. 10 can be added behind the step S625 of FIG. 6, the step S620 of FIG. 7 or the step S640 of FIG. 8.

Besides of that a target host which the file is going to be transferred to is represented by the specific data folder, a plurality of mechanisms/approaches can be used to represent the target host where the file is transferred. For example, the information switch module 100 can store a batch of target host information (for example, a predetermined value) in the system controller 170 for indicating the target host which the current file in the output storage space S1 is being transferred to. The user can control the information switch module 100 to select the second host corresponding to the current file in the output storage space S1 or the second host corresponding to the file to be stored in the output storage space S1. Controlling of the information switch module 100 can be implemented by performing a hotkey switching or pressing a physical key on the information switch module 100, etc. The hotkey switching can call out an on screen display (OSD) of the information switch module 100, and the target host information stored in the system controller 170 can be modified through the OSD. After the user stores a file to the output storage space S1 of the first host, the system controller 170 can transfer a corresponding data of the file to the corresponding second host according to the current target host information. In the present embodiment, the output storage space S1 of each host no longer has the directories corresponding to the other hosts, and related information are stored in the system controller 170 of the switch, so that the user can control the information switch module 100 to select the input storage space S2 of the host that corresponds to the output storage space S1 of a certain host. Such operation concept is similar to the embodiment of FIG. 3, only that the output storage space S1 of the host no longer has the directories corresponding to the other hosts.

By operating the information switch module 100, the user can set the output storage space S1 of a specific host to correspond to the input storage spaces S2 of a plurality of the other hosts. By such means, a one-to-many transfer function of the system can be implemented.

When the information switch module 100 is operated to select the input storage space S2 of the target host, the step S625 of FIG. 6, FIG. 7 and FIG. 8 can be cancelled. Meanwhile, in the step S630 thereof, the file can be only stored in the output storage space S1 since there are no specific data folders corresponding to the other hosts. Moreover, the step S640 thereof is also modified, by which the file stored in the output storage space S1 is transferred to the corresponding input storage space S2.

When the user operates the information switch module 10 to select the target host to delete the stored files, since the information switch module 100 cannot identify whether a certain file is stored in the input storage space S2 of a certain host according to a current setting, the input storage space S2 having a same file name probably has to be searched according to a searching method, or a corresponding table between a copied file and a target input storage space S2 is stored in the switch. Due to the above reason, the flowchart of FIG. 9 cannot be directly used when the switch is operated to select the target input storage space S2, and the aforementioned method has to be used for assistance.

In summary, the present disclosure provides a secure point-to-point or point-to-multipoint cross-platform data share mechanism, in which installing of any extra driving program or application program to the host is unnecessary. Therefore, with the present disclosure maintaining/managing a data/file share platform become low-cost and easy.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. An information switch module, serving as an information switch medium among a plurality of hosts, wherein the hosts at least comprise a first host and a second host, the information switch module comprising:
a storage device; and
a switch, at least comprising:
a system controller, coupled to the storage device for managing and controlling the storage device, and using the storage device to simulate at least two simulated Universal Serial Bus (USB) mass storage devices, and respectively setting up an output storage space and an input storage space in the at least two simulated USB mass storage devices;
a first USB interface controller, coupled to the system controller and the first host, and the first host accessing the output storage space through the first USB interface controller;
a second USB interface controller, coupled to the system controller and the second host, and the second host accessing the input storage space through the second USB interface controller; and
an input device connection module, coupled to at least one input device, the first USB interface controller and the second USB interface controller for providing the at least one input device to the first host, and providing a virtual device signal corresponding to the at least one input device to the second host,
wherein after the first host stores at least one file into the output storage space, the system controller provides a corresponding data of the at least one file to the input storage space for the second host.

2. The information switch module as claimed in claim 1, wherein the switch comprises the storage device.

3. The information switch module as claimed in claim 1, wherein the output storage space and the input storage space are configured in the same simulated USB mass storage device.

4. The information switch module as claimed in claim 1, wherein the system controller comprises:
a host interface controller, coupled to the first USB interface controller and the second USB interface controller for respectively providing the at least two simulated USB mass storage devices to the first host and the second host.
a control unit, coupled to the host interface controller for using the storage device to set the at least two simulated USB mass storage devices; and
a storage controller, coupled to the control unit and the storage device for executing an accessing command from the control unit to the storage device.

5. The information switch module as claimed in claim 1, wherein the system controller establishes a file system for the output storage space and the input storage space, respectively.

6. The information switch module as claimed in claim 5, wherein the system controller establishes a data folder in the output storage space, and the first host provides the corresponding data to the second host by storing the at least one file into the data folder.

7. The information switch module as claimed in claim 5, wherein the system controller establishes a data folder corresponding to the second host in the output storage space, and the first host provides the corresponding data to the second host by storing the at least one file into the data folder corresponding to the second host in the output storage space.

8. The information switch module as claimed in claim 1, wherein the system controller stores a target host information corresponding to the output storage space, and the first host provides the corresponding data to the second host corresponding to the target host information by storing the at least one file into the output storage space.

9. The information switch module as claimed in claim 1, wherein the input device connection module comprises a keyboard connection module coupled to a keyboard, the first USB interface controller and the second USB interface controller, for providing the keyboard to the first host and providing a virtual keyboard signal to the second host.

10. The information switch module as claimed in claim 1, further comprising:
a display connection module, coupled to at least one display and the first and the second hosts, for selectively providing the at least one display to one of the hosts.

11. The information switch module as claimed in claim 1, further comprising:
a display connection module, coupled to the first USB interface controller, the second USB interface controller and at least one display, for selectively providing the at least one display to one of the hosts.

12. The information switch module as claimed in claim 1, wherein the input device connection module comprises a cursor control device connection module coupled to a cursor control device, the first USB interface controller and the second USB interface controller for providing the cursor control device to the first host and providing a virtual cursor control device signal to the second host.

13. A file transfer method applying an information switch module, the information switch module serving as an information switch medium among a plurality of hosts, and the hosts at least comprising a first host and a second host, the file transfer method comprising:
simulating at least two simulated USB mass storage devices in a storage device by the information switch module;
respectively setting an output storage space and an input storage space in the at least two simulated USB mass storage devices;
configuring the output storage space for the first host;
storing at least one file in the output storage space by the first host; and
providing a corresponding data of the at least one file to the input storage space for the second host.

14. The file transfer method as claimed in claim 13, further comprising:
providing at least one input device to the first host; and
providing a virtual device signal corresponding to the at least one input device to the second host.

15. The file transfer method as claimed in claim 13, wherein the output storage space and the input storage space are configured in the same simulated USB mass storage device.

16. The file transfer method as claimed in claim 13, wherein the corresponding data is a copy of the at least one file.

17. The file transfer method as claimed in claim 13, further comprising:
correspondingly deleting/modifying the corresponding data in the input storage space by the information switch module after the first host deletes/modifies the at least one file in the output storage space.

18. The file transfer method as claimed in claim 13, wherein the corresponding data is a pointer pointed to an actual address of the at least one file.

19. The file transfer method as claimed in claim 13, further comprising:
forbidding the hosts editing the corresponding data stored in the input storage space.

20. The file transfer method as claimed in claim 13, further comprising:
respectively establishing a file system for the output storage space and the input storage space.

21. The file transfer method as claimed in claim 20, further comprising:
forbidding the hosts deleting/renaming/adding a specific data folder at a specific position in the output storage space.

22. The file transfer method as claimed in claim 20, further comprising:
establishing a data folder in the output storage space, wherein the first host provides the corresponding data to the second host by storing the at least one file into the data folder.

23. The file transfer method as claimed in claim 20, further comprising:
establishing a data folder corresponding to the second host in the output storage space, wherein the first host provides the corresponding data to the second host by storing the at least one file into the data folder corresponding to the second host in the output storage space.

24. The file transfer method as claimed in claim 13, further comprising:
storing a target host information corresponding to the output storage space by a system controller, wherein the first host provides the corresponding data to the second host corresponding to the target host information by storing the at least one file into the output storage space.

25. The file transfer method as claimed in claim 13, further comprising:
configuring the input storage space for the second host.

26. The file transfer method as claimed in claim 25, wherein the step of providing the corresponding data to the input storage space for the second host comprises:
stopping configuring the input storage space for the second host;
copying the at least one file in the output storage space to the input storage space; and
reconfiguring the input storage space for the second host.

27. The file transfer method as claimed in claim 25, further comprising:
correspondingly deleting the corresponding data in the input storage space and stopping configuring the input storage space for the second host after the first host deletes the at least one file in the output storage space.
